(19) United States
(12) Patent Application Publication
(10) Pub. No.: US 2008/0140933 A1
(43) Pub. Date: Jun. 12, 2008

(54) METHOD AND APPARATUS FOR DISPLAYING FILE IN TERMINAL HAVING REMOVABLE MEMORY DEVICE

(75) Inventor: Yeon Kyu Choi, Gumi-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/829,416

(22) Filed: Jul. 27, 2007

(30) Foreign Application Priority Data
Dec. 12, 2006 (KR) 10-2006-0125924

(51) Int. Cl. G06F 12/16; G06F 12/00

(52) U.S. Cl. 711/115; 711/162; 711/E12.103; 711/E12.001

(57) ABSTRACT

A method and apparatus for displaying a file in a terminal that may immediately move to a recently copied or selected file, when a removable memory device is inserted into the terminal, are provided. The method of displaying a file in a terminal having a removable memory device includes inspecting access path information of a file stored in the removable memory device when the removable memory device is connected to the terminal, the access path information being stored in a first hidden file, and displaying the file having the access path information.

### CROSS REFERENCE TO RELATED APPLICATION

This application claims priority from and the benefit of Korean Patent Application No. 10-2006-0125924, filed on Dec. 12, 2006, which is hereby incorporated herein by reference for all purposes as if fully set forth herein.

### BACKGROUND OF THE INVENTION

1. Field of the Invention

The present invention relates to a method and apparatus for displaying a file in a terminal, and more particularly, to a method and apparatus for displaying a file in a terminal that may allow a user to immediately find a recently copied or selected file when a removable memory device is inserted into the terminal.

2. Discussion of the Background

A conventional terminal includes an operation algorithm including software to provide communication and various additional services and a memory unit to store a file input by a user.

Conventional terminals often also include cameras and by using various user functions provided through such a terminal, a user may store a picture file photographed using the camera in the terminal, download a file such as a moving image through a wireless connection to the Internet or another computer and store the downloaded file in the terminal, or download an application program such as a game, store the program in a flash memory, and then execute the program through Virtual Memory (VM).

However, it may be impossible or difficult to replace or expand the memory in a terminal. That is, the memory size of a terminal is generally limited to the internal memory provided during manufacturing of the terminal and it may be difficult to expand the memory after the terminal has been manufactured.

Users may share a program or a file using a personal computer (PC) or local area wireless communication module. However, when using a PC, the PC may need to be prepared to share the file, and when using a local area wireless communication module, the terminals may need to have the same module in order to share the file.

In order to increase user convenience, a removable memory device for freely moving and sharing a program or a file between the terminals may be used.

A method of using a removable memory device to expand the memory of a conventional terminal is as follows. The removable memory device may be inserted into the terminal. Then a search may be conducted to find the file to be copied from the terminal to the removable memory device. When the file is found, it may be copied to the removable memory device. Next, the removable memory device may be separated from the terminal and connected to another terminal to which the file is to be copied.

When the removable memory device is connected to a terminal, a user may select a menu to display files stored in the removable memory device among menus displayed in the terminal, search for the file to be copied to the terminal, and select and copy the file to the terminal.

As described above, when connecting the removable memory device to the terminal and copying a file stored in the removable memory device to the terminal, a user may need to find the folder in which the file to be copied is stored. However, if many upper-level folders exist in the removable memory device, it may take a long time to find the folder. In addition, if many files in addition to the file to be copied exist in the folder, it may be difficult to find the corresponding file.

### SUMMARY OF THE INVENTION

The present invention provides a method and apparatus for displaying a file in a terminal that may generate access path information of a file stored in a removable memory device so as to quickly find the stored file when the removable memory device is connected to the terminal.

The present invention also provides a method and apparatus for displaying a file in a terminal that may quickly find a selected file among files stored in a removable memory device when the removable memory device is connected to the terminal.

The present invention also provides a method and apparatus for displaying a file in a terminal that may generate copy time information and a list of the files stored in a removable memory device so as to quickly find to the stored file when the removable memory device is connected to the terminal.

Additional features of the invention will be set forth in the description which follows, and in part will be apparent from the description, or may be learned by practice of the invention.

The present invention discloses a method of displaying a file in a terminal having a removable memory device, including inspecting access path information of a file stored in the removable memory device when the removable memory device is connected to the terminal, the access path information being stored in a hidden file, and displaying the file having the access path information.

The present invention also discloses a method of displaying a file in a terminal having a removable memory device, including copying a file to the removable memory device or selecting a file stored in the removable memory device, generating copy time information and access path information of the copied file or generating access path information of the selected file, and storing the generated information in the removable memory device.

The present invention also discloses a method of displaying a file in a terminal having a removable memory device, including copying a file from the first terminal to the removable memory device, generating and storing access path information of the file, and displaying the access path information when the removable memory device is connected to a second terminal.

The present invention also discloses a terminal having a file display function, including a connection unit connected to an external device, a memory unit to store files, a controller, and a display unit. The controller generates copy time information and access path information of a file that is copied to the external device or generates access path information of a file stored in the external device that is selected. The generated information is stored in a hidden file in the external device, and the display unit displays the files stored in the external device using the hidden file.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view showing a terminal and a removable memory device according to an exemplary embodiment of the present invention.

FIG. 2 is a block diagram showing a configuration of a terminal according to according to an exemplary embodiment of the present invention.

FIG. 3 is a flowchart showing an operation for copying a file stored in a terminal to a removable memory device or selecting a file stored in the removable memory device according to an exemplary embodiment of the present invention.

FIG. 4A and FIG. 4B are diagrams showing an operation screen of FIG. 3.

FIG. 5 is a flowchart showing an operation for copying a file stored in a removable memory device to a terminal according to an exemplary embodiment of the present invention.

FIG. 6A, FIG. 6B, and FIG. 6C are diagrams showing an operation screen of FIG. 5.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

In exemplary embodiments of the present invention, a “hidden file” is a file for storing access path information of a file to be copied from a terminal to a removable memory device or a specific file stored in a removable memory device, and copy time information of a file copied from a terminal. An “access path of a file” is an access path of a file stored in a removable memory device. For example, if a specific file is stored in a ‘My pictures’ folder, which is a lower-level folder of a ‘My documents’ folder, the ‘My documents’ folder may provide an access path to the ‘My pictures’ folder. Further, “copy time information” is a time at which a file stored in a terminal is copied to a removable memory device.

A “removable memory device” is a memory device that may be connected to the terminal, whereby a file stored in the terminal may be transferred or copied to the removable memory device, and a file stored in the removable memory device may be transferred or copied to the terminal. Here, the removable memory device may be a storage medium to simply store a file or may be a memory device including a controller to control the storage medium. In the present exemplary embodiment, a removable memory device as a storage medium to simply store a file is exemplified.

Further, a terminal according to an exemplary embodiment of the present invention may be an information communication device or a multimedia device, such as a mobile phone, a wired phone, a wireless phone, a Personal Digital Assistant (PDA), a smart phone, an audio appliance, an MP3 player, a notebook computer, or a personal computer, and may be applied to applications thereof.

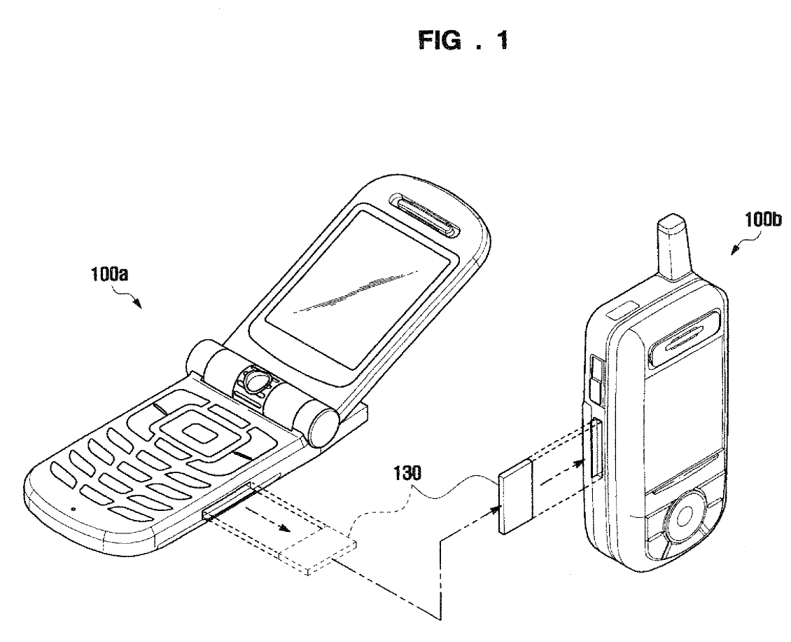

FIG. 1 is a perspective view showing a terminal and a removable memory device according to an exemplary embodiment of the present invention.

Referring to FIG. 1, a plurality of terminals, for example, a first terminal 100a, second terminal 100b, and a removable memory device 130 are provided.

The removable memory device 130 may be detachable, and the removable memory device 130 may be a storage medium that can be detached or connected to the first and second terminals 100a and 100b to transfer and copy a file. A memory card such as a Security Digital (SD) memory card, a Compact Flash (CF) memory card, a multimedia card, a memory stick, or a storage medium such as a removable disk may be used as the removable memory device 130. Alternatively, a memory device including a memory card and a controller to control the memory card may be used as the removable memory device 130.

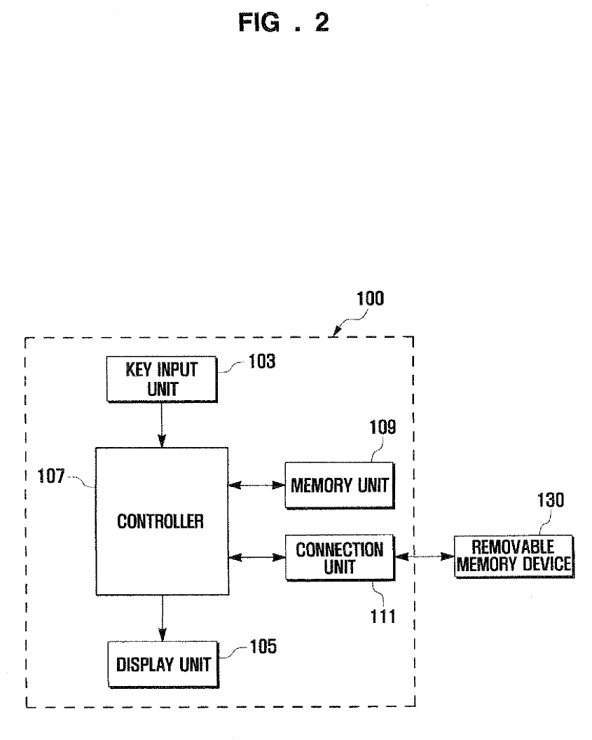

FIG. 2 is a block diagram showing a configuration of a terminal according to an exemplary embodiment of the present invention.

Referring to FIG. 2, the terminal 100 may include a key input unit 103, a display unit 105, a controller 107, a memory unit 109, and a connection unit 111.

The key input unit 103 receives a user's manipulation signal to control operation of the terminal 100. For example, using the key input unit 103, a user may set a file display function, copy a file to the removable memory device 130, and select or copy a file stored in the removable memory device 130.

The display unit 105 displays data output by the controller 107. The display unit 105 may use a liquid crystal display (LCD), and in this case, the display unit 105 includes an LCD controller, memory for storing an image file, and an LCD display element. When the display unit 105 has touch screen capabilities, the display unit 105 may be operated as an input unit.

In a state where a file display function is set, the display unit 105 displays a pop-up window for selecting whether to display a file using access path information stored in a hidden file when the removable memory device 130 is connected to the terminal 100. If file display of the access path information is selected, the display unit 105 displays a file corresponding to the access path information. Further, if the removable memory device 130 is connected to the terminal 100, the display unit 105 may arrange and display files stored in the removable memory device 130 according to copy time using copy time information stored in a hidden file.

The controller 107 controls the general operation of the terminal 100. The controller 107 also controls a file display function.

The controller 107 generates access path information and/or copy time information in order to control the file display function and stores the generated information in a hidden file. When a file is copied to the removable memory device 130, the controller 107 generates access path information and stores the information in the hidden file, and then stores the hidden file in the removable memory 130 device. Alternatively, when a specific file stored in the removable memory device 130 is selected, the controller 107 generates access path information of the file and stores a hidden file to store the access path information in the removable memory device 130. If the removable memory device 130 is connected to the terminal 100, the controller 107 determines whether a hidden file exists, and if a hidden file exists, the controller 107 controls the terminal to display a pop-up window for selecting movement to an access path in the display unit 105.

Further, the controller 107 may also generate file copy time information. The file copy time information is information about the time at which a file is copied. More particularly, file copy time information includes the time when a file stored in the terminal 100 is copied to the removable memory device 130. When a file is copied to the removable memory device 130, the controller 107 generates file copy time information and stores the file copy time information in a hidden file in the removable memory device 130. If the removable memory device 130 is connected to the terminal 100, the controller 107 determines whether a hidden file exists, and if a hidden file exists, the controller 107 controls the terminal to display the copy time information in the display unit 205.

Further, the controller 107 generates both access path information and copy time information and stores the information in a hidden file in the removable memory device 130 or selects a file and generates access path information and stores the generated information in a hidden file.

The memory unit 109 includes program memory and file memory. Programs to control the general operation of the terminal 100 and programs to perform a file display function according to the present exemplary embodiment are stored in the program memory. Files generated while performing a program are stored in the file memory. In the memory unit 109, various kinds of files for copying to the removable memory device 130, for example, picture files or music files, may be stored. In the memory unit 109, several kinds of files copied from the removable memory device 130 may be stored.

The connection unit 111 may be an insertion hole into which the removable memory device 130 may be inserted. A memory socket may be fixed to a circuit board within the terminal 100, and the removable memory device 130 may be inserted into and separated from the insertion hole corresponding to the memory socket. The inserted removable memory device 130 is connected to the terminal 100, and either a file of the terminal 100 may be transferred or copied to the removable memory device 130 or a file of the removable memory device 130 may be transferred or copied to the terminal.

Hereinafter, a method of displaying a file in a terminal according to an exemplary embodiment of the present invention is described.

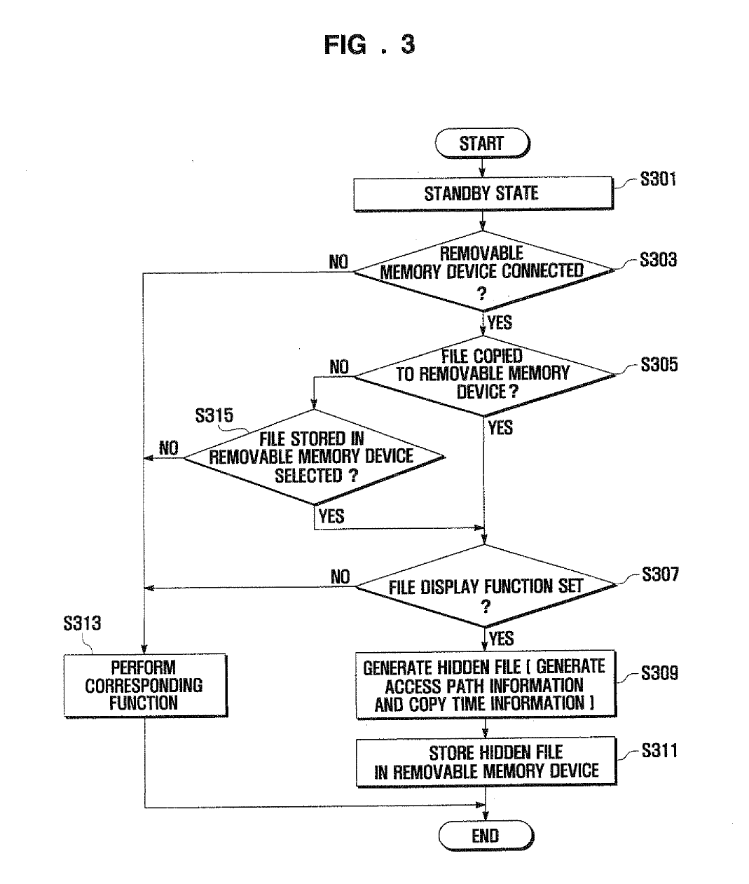

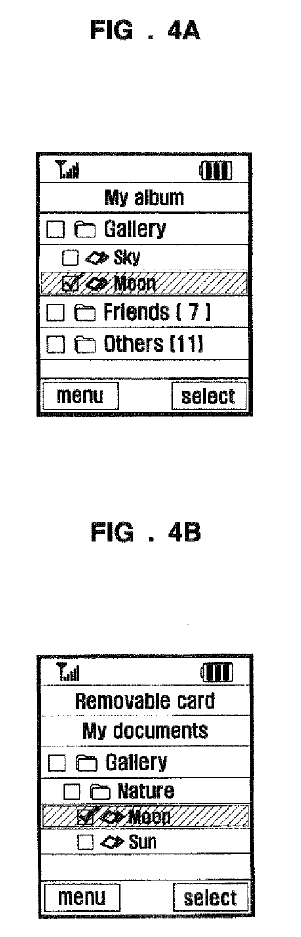

FIG. 3 is a flowchart showing the operation for copying a file stored in a terminal to a removable memory device or selecting a file stored in the removable memory device according to an exemplary embodiment of the present invention. FIGS. 4A and 4B are diagrams showing an operation screen of FIG. 3.

Referring to FIG. 1, FIG. 2, FIG. 3, FIG. 4A, and FIG. 4B, a method of copying a file stored in the first terminal 100a to the removable memory device 130 or selecting, by the first terminal 100a, a file stored in the removable memory device 130 is described.

As shown in FIG. 3, when the first terminal 100a is in a standby state (S301), the controller 107 determines whether a removable memory device 130 is connected to the first terminal 100a (S303). For example, the controller 107 may determine whether a removable memory device 130 is connected to the first terminal 100a through the connection unit 111. If the removable memory 130 is not connected to the first terminal 100a, the controller 107 performs a function corresponding to the user's request (S313).

If the removable memory 130 is connected to the first terminal 100a, the controller 107 determines whether a specific file stored in the memory unit 109 of the first terminal 100a has been selected by the user and copied to the removable memory device 130 (S305). A screen for selecting a file to be copied to the removable memory 130 is shown in FIG. 4A. As shown in FIG. 4A, the user selects the picture file to copy a ‘moon’ picture in a ‘Gallery’ folder of a ‘My album’ menu of the first terminal 100a to the removable memory device 130. The controller 107 recognizes that a file is selected through the key input unit 103 and displays the file selected in a list on the display unit 105 or displays the content of the selected file on the display unit 105.

The controller 107 copies the selected file to the removable memory device 130. After a file to be copied is selected, a screen for copying the file to a desired folder of the removable memory device 130 is shown in FIG. 4B. As shown in FIG. 4B, a ‘Moon’ picture stored in the memory unit 109 of the first terminal 100a may be copied to a ‘Nature’ folder, which is a lower-level folder of a ‘Gallery’ folder of a ‘My documents’ menu of the removable memory device 130.

If a specific file stored in the memory unit 109 of the first terminal 100a is not copied to the removable memory device 130 at step S305, the controller 107 determines whether a specific file stored in the removable memory device 130 is selected by the user (S315).

If a specific file of the removable memory device 130 is not selected at step S315, the controller 107 performs a function corresponding to the user's request (S313).

If a specific file stored in the memory unit 109 of the first terminal 100a is copied to the removable memory device 130 at step S305 or if a specific file stored in the removable memory device 130 is selected at step S315, the controller 107 determines whether a file display function is set (S307). If a file display function is not set, the controller 107 performs a function corresponding to the user's request (S313).

If a file display function is set (S307), the controller 107 generates a hidden file (S309). Access path information of a file copied to the removable memory device 130 is stored in the hidden file, for example, access path information of a recently copied file may be stored or, when a specific file stored in the removable memory device 130 is selected, access path information of the selected file may be stored in the hidden file. That is, access path information of the file copied to the removable memory device 130 at step S305 or access path information due to selection of the file stored in the removable memory device 130 at step S315 may be generated in a hidden file.

A hidden file storing access path information of the file stored in the removable memory device 130 stores information relating to the path to which the ‘Moon’ picture has been copied, as shown in FIG. 4B, and also stores information regarding an access path through a ‘Nature’ folder in a ‘Gallery’ folder of a ‘My documents’ menu of the removable memory device 130. When a ‘Moon’ picture stored in the removable memory device 130 is selected as shown in FIG. 4B, a hidden file storing access path information of a specific file selected in the removable memory device 130 stores information of the path in which the ‘Moon’ picture was selected and also stores information regarding an access path through a ‘Nature’ folder in a ‘Gallery’ folder of a ‘My documents’ menu of the removable memory device 130.

Thereafter, the controller 107 stores the hidden file in the removable memory device 130 (S311). When a file is selected for copying, the controller 107 copies the selected file to the removable memory device 130 at step S305 and simultaneously stores a hidden file of file access path information generated at step S309 in the removable memory device 130. When a file is already stored in the removable memory device 130, the controller 107 stores a hidden file of access path information of the file selected at step S315 in the removable memory device 130.

In addition to storing access path information in a hidden file, if a file display function is set at step S307, the controller 107 may also generate copy time information of the file and stores the information in the hidden file (S309). The copy time information of the file is a copy time of the file copied to the removable memory device 130. The controller 107 copies the file selected for copying to the removable memory device 130 at step S305, and simultaneously generates the copy time information of the file and stores the generated copy time information in the hidden file at step S309.

The controller 107 then stores the hidden file in which the copy time information of the file is stored in the removable memory device 130 (S311).

The controller 107 may copy the file selected at step S305 to the removable memory device 130 and store both the recent access path information and the copy time information generated at step S309 in a hidden file in the removable memory device 130 or may generate information of only one of the recent access path and the copy time information and store the information in a hidden file.

Next, in a method of displaying a file in a terminal according to the present exemplary embodiment, a method of copying a file stored in a removable memory device to a terminal is described.

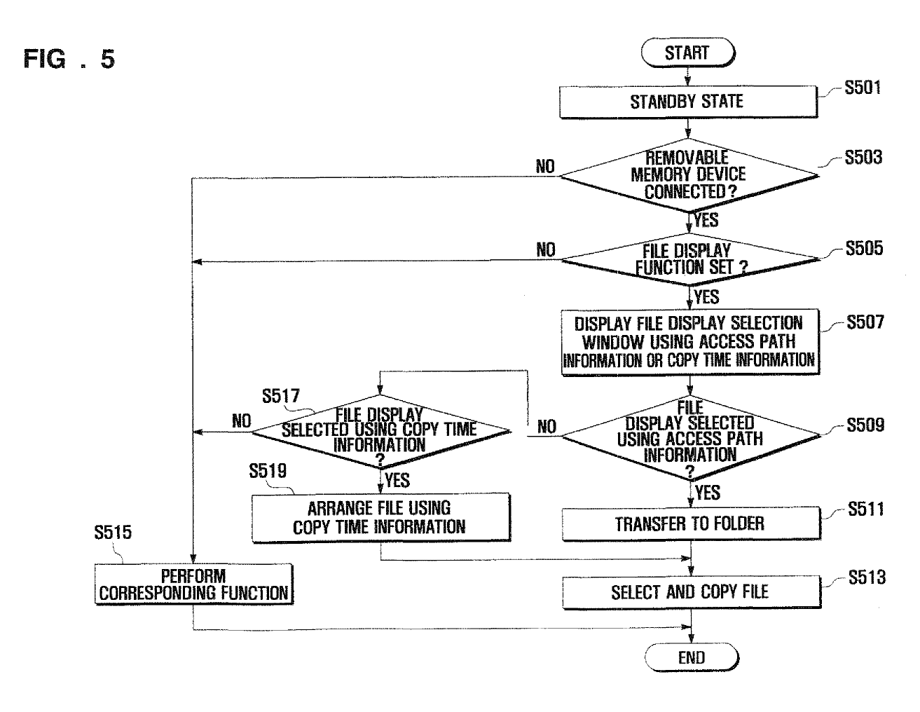

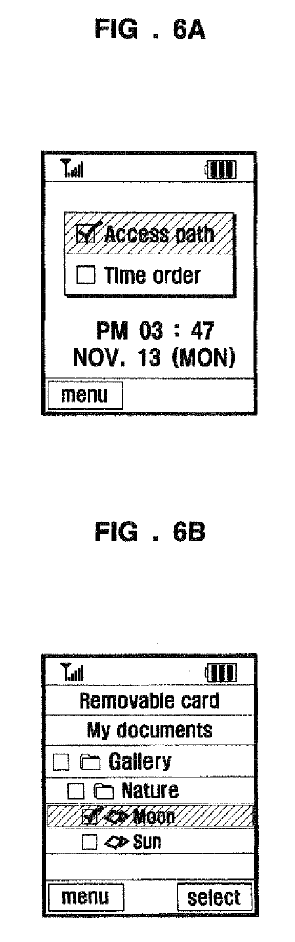

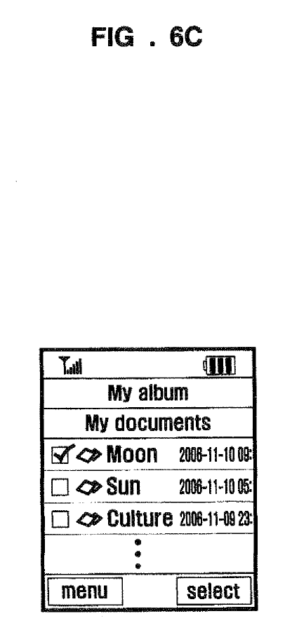

FIG. 5 is a flowchart showing an operation for copying a file stored in a removable memory to a terminal according to the present exemplary embodiment. FIG. 6A, FIG. 6B, and FIG. 6C are diagrams showing an operation screen of FIG. 5.

Referring to FIG. 1, FIG. 2, FIG. 5, FIG. 6A, FIG. 6B, and FIG. 6C, a method of copying a file stored in the removable memory device 130 to the second terminal 100b is described below. As shown in FIG. 5, when the second terminal 100b is in a standby state (S501), the controller 107 determines whether the removable memory device 130 is connected to the second terminal 100b (S503). If the removable memory device 130 is not connected to the second terminal 100b, the controller 107 performs a function corresponding to a user's request (S515).

If the removable memory device 130 is connected to the second terminal 100b, the controller 107 determines whether a file display function is set (S505). If a file display function is not set, the controller 107 performs a function corresponding to the user's request (S515).

If a file display function is set, the controller 107 displays a file display selection window for selecting display of files according to either access path information or copy time information stored in a hidden file (S507). A screen displaying a pop-up window for selecting either a time order in which files are displayed according to the copy time information stored in the hidden file, or an access path order in which files are displayed according to the access path information stored in the hidden file, is shown in FIG. 6A. As shown in FIG. 6A, if the removable memory device 130 is connected to the second terminal 100b, a pop-up window for selecting a method of displaying files stored in the removable memory device 130 may be displayed on the display unit 105.

Next, the controller 107 determines whether the file display according to the access path information is selected by the user (S509). If the file display according to the access path information is selected as shown in FIG. 6A, the controller 107 displays stored files according to access path information for user selection, and transfers the file selected by the user using the access path information stored in the hidden file to a folder of the removable memory device 130 (S511). When file display according to access path information is selected, the screen moves to a folder of the removable memory device 130, as shown in FIG. 6B. If the file display according to the access path information is selected at step S509, the selected file among files copied to the removable memory device 130 through step S305 of FIG. 3 or stored in the removable memory device 130 at step S315 of FIG. 3 may be displayed.

Next, according to a user's input, the controller 107 selects and copies the displayed file (S513). A file displayed in the display unit 105 may be selected through the key input unit 103 and the file may be copied to the second terminal 100b or executed.

If the file display according to the copy time information is selected (S517), the controller 107 arranges and displays the stored files according to the copy time information of each file (S519). As shown in FIG. 6C, files stored in the removable memory device 130 may be arranged and displayed in the display unit 105 in a time order according to the copy time information.

If neither an access path order nor a copy time order is selected at step S509 or step S517, respectively, the controller 107 performs a function corresponding to the user's request (S515).

Next, the controller 107 recognizes that a file to be copied has been selected by the user's input, and the file may be copied to the second terminal 100b or executed (S513).

When only access path information of the copied file is generated and the information is stored in a hidden file at steps S309 and S311 of FIG. 3, a selection window for selecting the movement to the access path is displayed at step S507, and steps S511 and S513 may then be performed. When only copy time information is generated and stored in a hidden file at steps S309 and S311 of FIG. 3, a selection window for selecting the file display using the copy time information is displayed at step S507, and steps S519 and S513 may then be performed.

In a method and apparatus for displaying a file in a terminal according to the present exemplary embodiment, when a removable memory device in which the file is stored is inserted into a terminal, a recently copied or selected file may be displayed to quickly transfer files arranged in a recently copied time information order. Accordingly, a user may easily find a recently copied or selected file in the removable memory device and thus, user convenience may be improved.

The present exemplary embodiment exemplifies a removable memory device having a simple storage function, and when a file is copied to the removable memory device or when a file stored in the removable memory device is selected, access path information or copy time information of the file may be generated and the generated information may be stored in the removable memory device in a hidden file. However, for example, by using a removable memory device including a controller, a controller of the removable memory device may control the process of generating access path information and copy time information and store the generated information in a hidden file. Then, in a similar manner to that of the present exemplary embodiment, a method and apparatus for displaying a file in a terminal may be executed.

As described above, according to the present invention, when a file is copied from a removable memory device connected to a terminal or a file stored in the removable memory device is selected, and the removable memory device is connected to another terminal, it may be possible to easily move to either a file recently copied to the removable memory device or a selected file or files arranged in a copied time information order, so that a user may easily find the file recently copied to the removable memory device or the selected file and thus, user convenience may be improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of displaying a file in a terminal having a removable memory device, the method comprising:
inspecting access path information of a file stored in the removable memory device when the removable memory device is connected to the terminal; and
displaying the file of the access path information.

2. The method of claim 1, further comprising:
copying the file to the removable memory device;
generating copy time information and access path information of the file; and
storing the copy time information and the access path information in the removable memory device.

3. The method of claim 1, further comprising:
selecting the file stored in the removable memory device;
generating access path information of the file; and
storing the access path information in the removable memory device.

4. The method of claim 1, wherein displaying the file comprises displaying a list of file names included in the access path information.

5. The method of claim 2, wherein displaying the file comprises arranging file names according to copy time information.

6. The method of claim 2, wherein inspecting access path information of a file stored in the removable memory device comprises displaying a pop-up window to allow a user to select between displaying files according to copy time information and displaying files according to access path information.

7. A method of displaying a file in a terminal having a removable memory device, comprising:
copying a file to the removable memory device or selecting a file stored in the removable memory device;
generating copy time information and access path information of the copied file or generating access path information of the selected file; and
storing the generated information in the removable memory device.

8. A method of displaying a file in a terminal having a removable memory device, comprising:
copying a file from a first terminal to the removable memory device;
generating and storing access path information of the file; and
displaying the file using the access path information when the removable memory device is connected to a second terminal.

9. The method of claim 8, wherein generating and storing access path information of the file comprises:
storing the access path information in the removable memory device.

10. The method of claim 8, wherein copying a file from the first terminal to the removable memory device comprises:
selecting the file to be copied from the first terminal to the removable memory device;
generating copy time information and access path information of the selected file; and
storing the information in the removable memory device.

11. The method of claim 9, further comprising storing the access path information in a hidden file.

12. A terminal having a file display function, the terminal comprising:
a connection unit connected to an external device;
a memory unit to store files;
a controller to generate copy time information and access path information of a file that is copied to the external device or to generate access path information of a file stored in the external device that is selected, the generated information being stored in the external device; and
a display unit to display the files stored in the external device using the copy time information or the access path information.

13. The terminal of claim 12, wherein the display unit arranges and displays the files according to copy time information.

14. The terminal of claim 12, wherein the external device is a card comprising a removable memory device or a controller.
